(19) United States
(12) Patent Application Publication
(10) Pub. No.: US 2019/0318700 A1
(43) Pub. Date: Oct. 17, 2019

(54) DISPLAY DEVICE AND METHOD FOR DRIVING THE SAME

(71) Applicant: SHARP KABUSHIKI KAISHA, Sakai City (JP)

(72) Inventors: YASUAKI IWASE, Sakai City (JP); TAKUYA WATANABE, Sakai City (JP); AKIRA TAGAWA, Sakai City (JP); TAKATSUGU KUSUMI, Sakai City (JP); YOHEI TAKEUCHI, Sakai City (JP)

(21) Appl. No.: 16/380,629

(22) Filed: Apr. 10, 2019

(30) Foreign Application Priority Data
Apr. 12, 2018 (JP) 2018-076502

(51) Int. Cl. G09G 3/36

(52) U.S. Cl. CPC G09G 3/3614; G09G 3/3677; G09G 2310/08; G09G 2310/0213; G09G 3/3688

(57) ABSTRACT

A precharge circuit configured to precharge source bus lines is provided in a display device employing an SSD method. In the case where an n-channel TFT is employed, the precharge circuit applies a precharge voltage to the source bus line connected to the pixel formation portions to be subjected to data writing of a positive polarity, before a video signal is applied to the source bus line. In each horizontal scanning period, an SSD circuit switches the source bus line of a connection. destination of a data output line so that the video signal is applied to the source bus line connected to the pixel formation portions to be subjected to the data writing of a negative polarity relatively prior to the source bus line connected to the pixel formation portions to be subjected to the data writing of the positive polarity.

### BACKGROUND OF THE INVENTION

### 1. Field of the Invention

The following disclosure relates to a display device and a method for driving the same, and particularly to a display device configured to drive video signal lines in a time division manner, and a method for driving the same.

### 2. Description of Related Art

With regard to a display device, in recent years, development of high resolution/high definition has been remarkable. Although it is necessary to increase video signal lines (source bus lines) in number in order to implement the high resolution, the increase of the video signal lines in number makes it necessary to enlarge a picture-frame region, thereby decreasing a freedom degree of design. Moreover, with the high definition, an interval of the video signal lines becomes narrower than conventional interval. As a result, an interval between each of output terminals of an IC (source driver) configured to drive the video signal lines and connection portions of the video signal lines becomes extremely small.

In light of the above-described situation, there has been proposed a driving method in which video signal lines are grouped by setting two or more video signal lines as one group, and one output terminal of a source driver is assigned to the plurality of video signal lines configuring each group to drive the plurality of video signal lines configuring each of the groups in a time division manner in each horizontal scanning period. The above-described driving method is called an “SSD method”. Note that SSD is an abbreviation of “Source Shared Driving”. According to a display device employing the SSD method, since a number of the output terminals required for source driver is decreased, a picture-frame region can be narrowed.

However, when the SSD method is employed, the video signal lines are driven in a time division manner, and thus, a charging time of the video signal lines becomes shorter than that in a normal driving method. When the charging time becomes shorter, a display defect may be easily caused due to insufficient charging. Consequently, in an electrooptical device (display device) described in Japanese Laid-Open Patent Publication No. 2015-87586, in a configuration employing the SSD method, precharge (preliminary charging) of the video signal lines is performed.

The insufficient charging when the SSD method is employed is easily caused particularly when the charging is performed at a high voltage (i.e., at the time of the data writing of a positive polarity) (in the case where an n-channel TFT is employed as a switching element). A reason for the foregoing is that when the charging at a high voltage is performed, as the charging is progressing, a gate-source voltage Vgs of the TFT becomes smaller, which lowers an operation point and decreases driving capability. However, in the electrooptical device described in Japanese Laid-Open Patent Publication No. 2015-87586, the precharge is performed both at the time of the data writing of the positive polarity and at the time of data writing of negative polarity. This makes unnecessarily large a power consumption by switch operation of the switching element such as the TFT or the like.

### SUMMARY OF THE INVENTION

An object of the following disclosure is therefore to realize a display device capable of driving video signal lines in a time division manner while suppressing an increase in power consumption.

Display devices according to several embodiments are each a display device including a plurality of video signal lines, a plurality of scanning signal lines intersecting with the plurality of video signal lines, a plurality of pixel formation portions arranged corresponding to respective intersections between the plurality of video signal lines and the plurality of scanning signal lines, and a scanning signal line drive circuit configured to drive the plurality of scanning signal lines, the display device including:

a video signal line drive circuit configured to output a video signal to a data output line in a time division manner in each horizontal scanning period, the data output line corresponding to each video signal line group obtained by grouping the plurality of video signal lines with video signal lines set as one group, where K is an integer of two or more;

a connection switching circuit including a connection control transistor configured to control an electrical connection state between each of the video signal lines and the data output line corresponding thereto, the connection switching circuit configured to switch a connection destination of the data output line corresponding to each of the video signal line groups among the K video signal lines configuring each of the video signal line groups in a time division manner in each of the horizontal scanning periods; and

a preliminary charging circuit configured to apply a preliminary charging voltage to the plurality of video signal lines,

wherein in a case where the connection control transistor is of an n-channel type,
in each of the horizontal scanning periods, the preliminary charging circuit applies the preliminary charging voltage to the video signal line connected to the pixel formation portions to be subjected to data writing of a positive polarity before the video signal outputted from the video signal line drive circuit is applied to the video signal line, and
in each of the horizontal scanning periods, the connection switching circuit switches the video signal line of the connection destination of the data output line so that the video signal outputted from the video signal line drive circuit is applied to the video signal line connected to the pixel formation portions to be subjected to the data writing of a negative polarity relatively prior to the video signal line connected to the pixel formation portions to be subjected to the data writing of the positive polarity,

in a case where the connection control transistor is of a p-channel type,
in each of the horizontal scanning periods, the preliminary charging circuit applies the preliminary charging voltage to the video signal line connected to the pixel formation portions to be subjected to the data writing of the negative polarity before the video signal outputted from the video signal line drive circuit is applied to the video signal line, and
in each of the horizontal scanning period, the connection switching circuit switches the video signal line of the connection destination of the data output line so that the video signal outputted from the video signal line drive circuit is applied to the video signal line connected to the pixel formation portions to be subjected to the data writing of the positive polarity relatively prior to the video signal line connected to the pixel formation portions to be subjected to the data writing of the negative polarity.

According to the above-described configuration, the preliminary charging circuit configured to apply the preliminary charging voltage to the video signal lines is provided. For example, in the case where the n-channel connection control transistor (transistor configured to control the electrical connection state between the video signal line and the data. output line corresponding thereto) is used, in each of the horizontal scanning periods, the preliminary charging circuit applies preliminary charging voltage to the video signal line connected to the pixel formation portions to be subjected to the data writing of the positive polarity. In this manner, since the preliminary charging of the video signal line connected to the pixel formation portions to be subjected to the data writing of the positive polarity is performed, the occurrence of the insufficient charging when the charging at a high voltage is performed is suppressed. Moreover, since the preliminary charging is not performed to all the video signal lines connected to the pixel formation portions to be subjected to the data writing of the negative polarity, a power consumption does not become unnecessarily large. From the foregoing, the display device capable of driving the video signal lines in a time division manner while suppressing an increase in the power consumption is realized.

Moreover, methods for driving a display device in several embodiments are each a method for driving a display device including including a plurality of video signal lines, a plurality of scanning signal lines intersecting with the plurality of video signal lines, a plurality of pixel formation portions arranged corresponding to respective intersections between the plurality of video signal lines and the plurality of scanning signal lines, a scanning signal line drive circuit configured to drive the plurality of scanning signal lines, a video signal line drive circuit configured to output a video signal to a data output line in a time division manner in each horizontal scanning period, and a connection switching circuit including a connection control transistor configured to control an electrical connection state between each of the video signal lines and the data output line corresponding thereto, the data output line corresponding to each video signal line group obtained by grouping the plurality of video signal lines with K video signal lines set as one group, where K is an integer of two or more, the connection switching circuit configured to switch a connection destination of the data output line corresponding to each of the video signal line groups among the K video signal lines configuring each of the video signal line groups, the method including:

a preliminary charging step of switching the connection destination of the data output line by the connection switching circuit so that, in a case where the connection control transistor is of an n-channel type, a preliminary charging voltage applied to the video signal line connected to the pixel formation portions to be subjected to data writing of a positive polarity and the video signal outputted from the video signal line drive circuit is applied to the video signal line connected to the pixel formation portions to be subjected to the data writing of a negative polarity and in a case where the connection control transistor is of a p-channel type, the preliminary charging voltage applied to the video signal line connected to the pixel formation portions to be subjected to the data writing of the negative polarity and the video signal outputted from the video signal line drive circuit is applied to the video signal line connected to the pixel formation portions be subjected to the data writing of the positive polarity; and

a primary charging step of switching the connection destination of the a output line by the connection switching circuit so that, in the case where the connection control transistor is the n-channel type, the video signal outputted from the video signal line drive circuit is applied to the video signal line connected to the pixel formation portions to be subjected to the data writing of the positive polarity, and in the case where the connection control transistor is of the p-channel type, the video signal outputted from the video signal line drive circuit is applied to the video signal line connected to the pixel formation portions to be subjected to the data writing of the negative polarity.

These and other objects, features, aspects, and effects of the present invention will be made more clear from the following detailed description of the present invention with reference to the accompanying drawings.

### BRIEF DESCRIPTION OF THE DRAWINGS

FIG. 1 is a block diagram showing an overall configuration of an active matrix-type liquid crystal display device according to a first embodiment.

FIG. 2 is a circuit diagram for describing configurations of an SSD circuit and a precharge circuit in the first embodiment.

FIG. 3 is a timing chart for describing operation in an odd-numbered frame in the first embodiment.

FIG. 4 is a diagram showing polarities of data writing in respective pixel formation portions in the odd-numbered frame in the first embodiment.

FIG. 5 is a timing chart for describing operation in an even-numbered frame in the first embodiment.

FIG. 6 is a diagram showing the polarities of the data writing in respective pixel formation portions in the even-numbered frame in the first embodiment.

FIG. 7 is a diagram showing a simulation result in a conventional general configuration.

FIG. 8 is a diagram showing a simulation result in a configuration according to the first embodiment.

FIG. 9 is a circuit diagram for describing configurations of an SSD circuit and a precharge circuit in a second embodiment.

FIG. 10 is a timing chart for describing operation in the odd-numbered frame in the second embodiment.

FIG. 11 is a diagram showing the polarities of the data writing in respective pixel formation portions in the odd-numbered frame in the second embodiment.

FIG. 12 is a timing chart for describing operation in the even-numbered frame in the second embodiment.

FIG. 13 is a diagram showing the polarities of the data writing in respective pixel formation portions in the even-numbered frame in the second embodiment.

FIG. 14 is a diagram for describing a case where the precharge circuit is arranged on a same side as a source driver with respect to a display portion.

FIG. 15 is a diagram for describing an arrangement of the precharge circuit in a modification of the respective embodiments.

FIG. 16 is a circuit diagram showing a configuration of an SSD/precharge circuit when the configuration according to the modification is applied to the first embodiment.

FIG. 17 is a circuit diagram showing a configuration of the SSD/precharge circuit when the configuration according to the modification is applied to the second embodiment.

### DETAILED DESCRIPTION OF PREFERRED EMBODIMENTS

Hereinafter, preferred embodiments will be described. Note that with regard to an n-channel transistor, one of a drain and a source with a higher potential is called a drain, but in the description of the present specification, since one is defined as a drain and the other as a source, a source potential may be higher than a drain potential.

### 1. First Embodiment

### 1.1 Overall Configuration and Overview of Operation

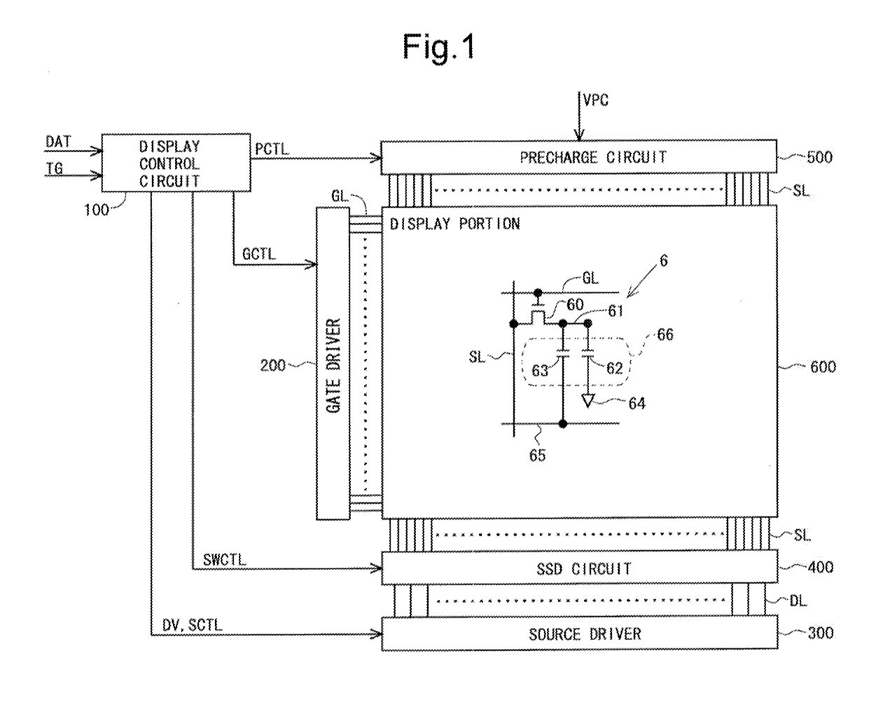

FIG. 1 is a block diagram showing an overall configuration of an active matrix-type liquid crystal display device according to a first embodiment. As shown in FIG. 1, this liquid crystal display device includes a display control circuit 100, a gate driver (scanning signal line drive circuit) 200, a source driver (video signal line drive circuit) 300, an SSD circuit (demultiplexer circuit) 400, a precharge circuit 500, and a display portion 600. Note that a connection switching circuit is implemented by the SSD circuit 400.

A plurality of source bus lines (video signal lines) SL and a plurality of gate bus lines (scanning signal lines) GL are arranged in the display portion 600. Pixel formation portions 6 configured to form pixels are provided so as to correspond to respective intersections between the plurality of source bus lines SL and the plurality of gate bus lines GL. That is, the display portion 600 includes the plurality of pixel formation portions 6. Each of the pixel formation portions includes a TFT (pixel TFT) 60 that is a switching element connected at a gate terminal thereof to a gate bus line GL passing through a corresponding intersection, and connected at a source terminal thereof to a source bus line SL passing through the intersection, a pixel electrode 61 connected to a drain terminal of the TFT 60; a common electrode 64 and an auxiliary capacitance electrode 65 that are provided so as to be shared by the plurality of pixel formation portions 6; liquid crystal capacitance 62 formed by the pixel electrode 61 and the common electrode 64; and an auxiliary capacitance 63 formed by the pixel electrode 61 and the auxiliary capacitance electrode 65. A pixel capacitance 66 is configured by the liquid crystal capacitance 62 and the auxiliary capacitance 63. In FIG. 1, only one pixel formation portion 6 is shown.

The gate bus lines GL are connected to the gate driver 200. The source bus lines SL are connected to the SSD circuit 400 and the precharge circuit 500. The SSD circuit 400 and the source driver 300 are connected by data output lines DL. In the present embodiment, a number of the data output lines DL is half a number of the source bus lines SL.

The display control circuit 100 receives an image signal DAT and a timing signal group TG such as a horizontal synchronizing signal and a vertical synchronizing signal, which are sent from an external source, and outputs a digital video signal DV, a gate control signal GCTL for controlling operation of the gate driver 200, a source control signal SCTL for controlling operation of the source driver 300, and a switching control signal SWCTL for controlling operation of the SSD circuit 400, and a precharge control signal PCTL for controlling operation of the precharge circuit 500. Note that the gate control signal GCTL includes a gate start pulse signal and a gate clock signal, and the source control signal SCTL includes a source start pulse signal, a source clock signal, and a latch strobe signal.

The gate driver 200 repeats application of an active scanning signal to each of the gate bus lines GL, based on the gate control signal GCTL sent from the display control circuit 100, with one vertical scanning period as a cycle.

Based on the digital video signal DV and the source control signal SCTL sent from the display control circuit 100, the source driver 300 outputs a video signal for driving to the data output line DL corresponding to each source bus line group in a time division manner in each horizontal scanning period, each of the source bus line groups being obtained by grouping the above-described plurality of source bus lines SL with the two source bus lines SL set as one group. At this time, in the source driver 300, the digital video signal DV indicating a voltage to be applied to each of the data output lines DL is sequentially held at timing when a pulse of the source clock signal generated. Then, the held digital video signal DV is converted into an analog voltage at timing when a pulse of toe latch strobe signal is generated. The converted analog voltages are simultaneously applied to all the data output lines DL as the video signal for driving.

Based on the switching control signal SWCTL sent, from the display control circuit 100, the SSD circuit 400 supplies the video signal sent from the source driver 300 through each of the data output lines DL to any one of the two source bus lines SL corresponding to each of the data output lines DL. The precharge circuit 500 applies a precharge voltage VPC to the source bus lines SL, based on the precharge control signal PCTL sent from the display control circuit 100. Detailed descriptions of the SSD circuit 400 and the precharge circuit 500 will be described later.

By applying the precharge voltage VPC and the video signal to the source bus lines SL, and applying the scanning signal to the gate bus lines GL in the above-described manner, an image based on the image signal DAT sent from the external source is displayed on the display portion 600.

### 1.2 SSD Circuit and Precharge Circuit

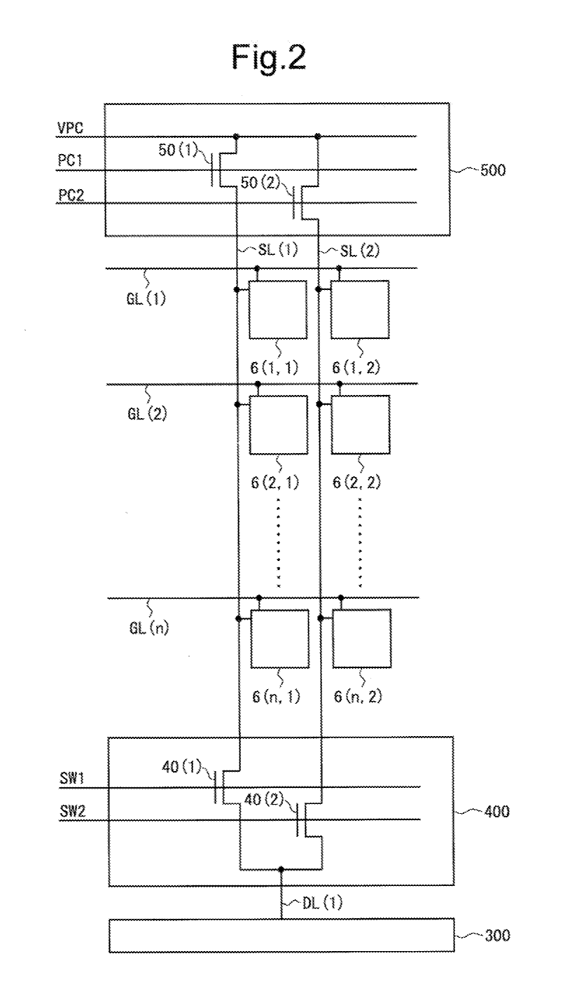

FIG. 2 is a circuit diagram for describing configurations of the SSD circuit 400 and the precharge circuit 500 in the present embodiment. In the present embodiment, with regard to driving of the source bus lines SL, two source bus lines SL are set as one driving unit. Therefore, in FIG. 2, only components corresponding to the one driving unit (specifically, components corresponding to source bus lines SL(1), SL(2) in a first column and a second column) are shown, and hereinafter, a description will be given, focusing on these components. Note that while the SSD circuit 400 and the precharge circuit 500 include a plurality of TFTs, hereinafter, the plurality of TFTs are discriminated by reference signs. Moreover, the plurality of pixel formation portions 6 are discriminated by reference signs. With respect to this, a pixel formation portion provided corresponding to an intersection between a gate bus line in a p-th row and a source bus line in a q-th column is followed by a sign 6(p,q). For example, a pixel formation portion with reference sign 6(2,1) is a pixel formation portion provided corresponding to an intersection between a gate bus line GL(2) in a second row and a source bus line SL(1) in a first column.

To the SSD circuit 400 are inputted a first switching control signal SW1 and a second switching control signal SW2 as the switching control signal SWCTL. To the precharge circuit 500 are inputted a first precharge control signal PC1 and a second precharge control signal PC2 as the precharge control signal PCTL. Moreover, to the precharge circuit 500 is supplied the precharge voltage VPC from a predetermined power supply circuit. Note that wiring for supplying the precharge voltage VPC to the precharge circuit 500 is hereinafter referred to as a “precharge power line”. The precharge voltage VPC is set to a maximum voltage of the video signal when data writing of a positive polarity is performed. Note that the “data writing” here means charging of the pixel capacitance 66 in the pixel formation portion 6 based on the video signal.

As shown in FIG. 2, the SSD circuit 400 is provided with a TFT 40(1) configured to control an electrical connection state between a data output line DL(1) and the source bus line SL(1) and a TFT 40(2) configured to control an electrical connection state between the data output line DL(1) and the source bus line SL(2). The TFT 40(1) and the TFT 40(2) are n-channel thin film transistors. As for the TFT 40(1), the first switching control signal SW1 is supplied to a gate terminal, a drain terminal is connected to the data output line DL(1), and a source terminal is connected to the source bus line SL(1). As for the TFT 40(2), the second switching control signal SW2 is supplied to a gate terminal, a drain terminal is connected to the data output line DL(1), and a source terminal is connected to the source bus line SL(2).

In the above-described configuration, when the video signal is to be applied to the source bus line SL(1), the display control circuit 100 sets the first switching control signal SW1 to a high level, and sets the second switching control signal SW2 to a low level. This brings the TFT 40(1) into an On state, and the TFT 40(2) into an Off state, so that the data output line DL(1) is electrically connected to the source bus line SL(1). On the other hand, when the video signal is to be applied to the source bus line SL(2), the display control circuit 100 sets the first switching control signal SW1 to the low level, and sets the second switching control signal SW2 to the high level. This brings the TFT 40(1) into an Off state, and the TFT 40(2) into an On state, so that the data output line DL(1) is electrically connected to the source bus line SL(2). As described above, the SSD circuit 400 in the present embodiment switches a connection destination of the data output line DL corresponding to each of the source bus line group between the two source bus lines SL configuring each of the source bus line groups in a time division manner in each horizontal scanning period. Note that, of the components shown in FIG. 2, the TFT 40(1) and the TFT 40(2) each correspond to a connection control transistor.

As shown in FIG. 2, the precharge circuit 500 is provided with a TFT 50(1) configured to control an electrical connection state between the precharge power line and the source bus line SL(1), and a TFT 50(2) configured to control an electrical connection state between the precharge power line and the source bus line SL(2). The TFT 50(1) and the TFT 50(2) are n-channel thin film transistors. As for the TFT 50(1), the first precharge control signal PC1 is supplied to a gate terminal, a drain terminal is connected to the precharge power line, and a source terminal is connected to the source bus line SL(1). As for the TFT 50(2), the second precharge control signal PC2 is supplied to a gate terminal, a drain terminal is connected to the precharge power line, and a source terminal is connected to the source bus line SL(2).

In the above-described configuration, when the precharge voltage VPC is to be applied to the source bus line SL(1), the display control circuit 100 sets the first precharge control signal PC1 to the high level. This brings the TFT 50(1) into an On state, so that the precharge cower line is electrically connected to the source bus line SL(1). When the precharge voltage VPC is to be applied to the source bus SL(2), the display control circuit 100 sets the second precharge control signal PC2 to the high level. This brings the TFT 50(2) into an On state, so that the precharge power line is electrically connected to the source bus line SL(2). As described above, the precharge circuit 500 applies the precharge voltage VPC to the source bus line SL that needs the precharge.

In light of decrease of level shifters for voltage generation in number, it is preferable that an amplitude of the switching control signal SWCTL (first switching control signal SW1, second switching control signal SW2) and an amplitude of she precharge control signal PCTL (first precharge control signal PC1, second precharge control signal PC2) are the same.

### 1.3 Driving Method

Next, a driving method will be described. In the present embodiment, so-called “column-reversal driving” is employed. That is, in each frame, the data writing having different polarities from each other is performed in the pixel formation portion 6 corresponding to the source bus lines SL in odd-numbered columns and in the pixel formation portions 6 corresponding to the source bus lines Sb in even-numbered columns. Moreover, in each of the pixel formation portions 6, the polarity of the data writing is reversed in each frame. From the foregoing, between the odd-numbered frame and the even-numbered frame, the overall operation differs. Note that in the following description, the scanning signal applied to each of the gate bus lines is followed by the same reference sign as the relevant gate bus line, the video signal applied to each of the data output lines is followed by the same reference sign as the relevant data output line, and the video signal applied to each of the source bus lines is followed by the same reference sign as the relevant source bus line. For example, the video signal applied to the source bus line SL(2) in the second column is followed by reference sign SL(2).

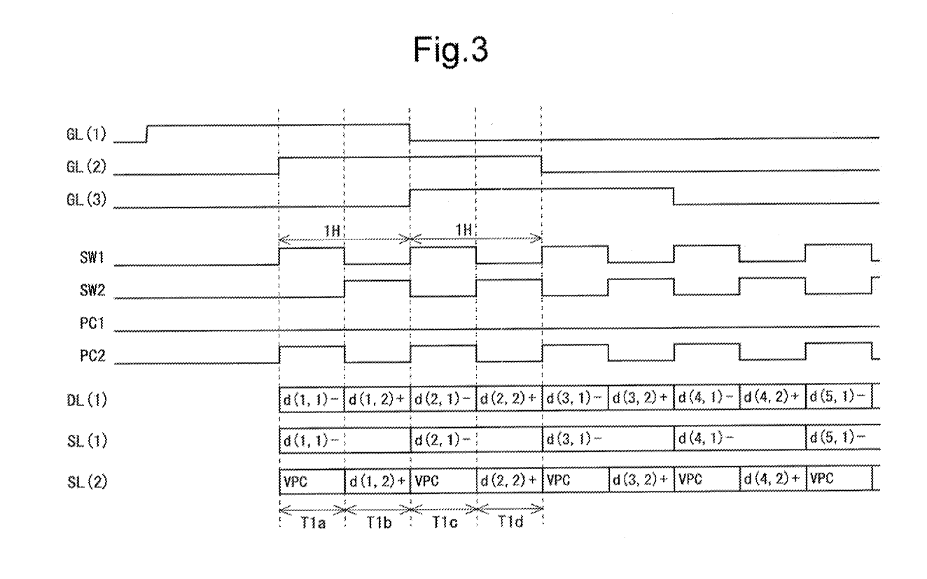

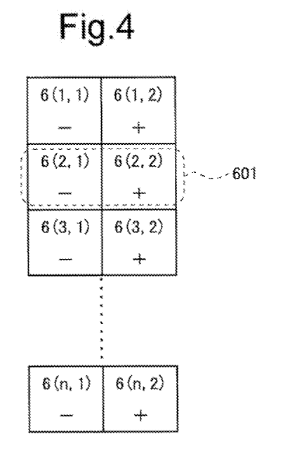

FIG. 3 is a timing chart for describing operation in the odd-numbered frame. FIG. 4 is a diagram showing the polarities of the data writing in the respective pixel formation portions 6 in the odd-numbered frame. For example, when a portion with reference sign 601 in FIG. 4 is focused on, it can be grasped that the data writing of the negative polarity is performed in the pixel formation portion 6(2,1) and the data writing of the positive polarity is performed in the pixel formation portion 6(2,2) in the odd-numbered frame. Note that in FIG. 3, data corresponding to each of the pixel formation portions 6 is denoted by a reference sign starting with “d”. With regard to this, a reference sign with an end of “+” denotes data of the positive polarity, while a reference sign with an end of “−” denotes data of the negative polarity. For example, “d(1,2)+” denotes the data of the positive polarity corresponding to a pixel formation portion 6(1,2). Moreover, for example, “d(4,1)−” denotes the data of the negative polarity corresponding to the pixel formation portion 6(4,1).

In a period T1a, a scanning signal G(1) and a scanning signal G(2) are each at the high level. In such a state, to the data output line DL(1) is supplied data d(1,1)− for a pixel formation portion 6(1,1) as the video signal. At this time, the first switching control signal SW1 is at the high level, and the second switching control signal SW2 is at the low level. Accordingly, the TFT 40(1) is in an On state, and the TFT 40(2) is in an Off state. Thereby, the data d(1,1)− is supplied to the source bus line SL(1), and the data d(1,1)− is written in the pixel capacitance 66 in the pixel formation portion 6(1,1). At this time, the first precharge control signal PC1 is at the low level and the second precharge control signal PC2 is at the high level. Accordingly, the TFT 50(1) is in an Off state, and the TFT 50(2) is in an On state. This allows the precharge voltage VPC to be applied to the source bus line SL(2).

Also in a period T1b, the scanning signal G(1) and the scanning signal G(2) are at the high level. In such a state, to the data output line DL(1) is supplied data d(1,2)+ for a pixel formation portion 6(1,2) as the video signal. At this time, in a state where the first precharge control signal PC1 is kept at the low level, the second precharge control signal PC2 is also at the low level. Thereby, since the TFT 50(2) is in an Off state, the application of the precharge voltage VPC to the source bus line SL(2) is stopped. Moreover, at this time, the first switching control signal SW1 is at the low level and the second switching control signal SW2 is at the high level. Accordingly, the TFT 40(1) is in an Off state, and the TFT 40(2) is in an On state. Thereby, the data d(1,2)+ is supplied to the source bus line SL(2), and the data d(1,2)+ is written in the pixel capacitance 66 in the pixel formation. portion. 6(1,2).

In a period T1c, in a state where the scanning signal G(2) and the scanning signal G(3) are at the high level, operation similar to that in the period T1a is performed. In a period T1d, in a state where the scanning signal G(2) and the scanning signal G(3) are at the high level, operation similar to that in the period T1b is performed. The above-described operation is repeated until the data writing in the pixel formation portions 6 in a final row ends.

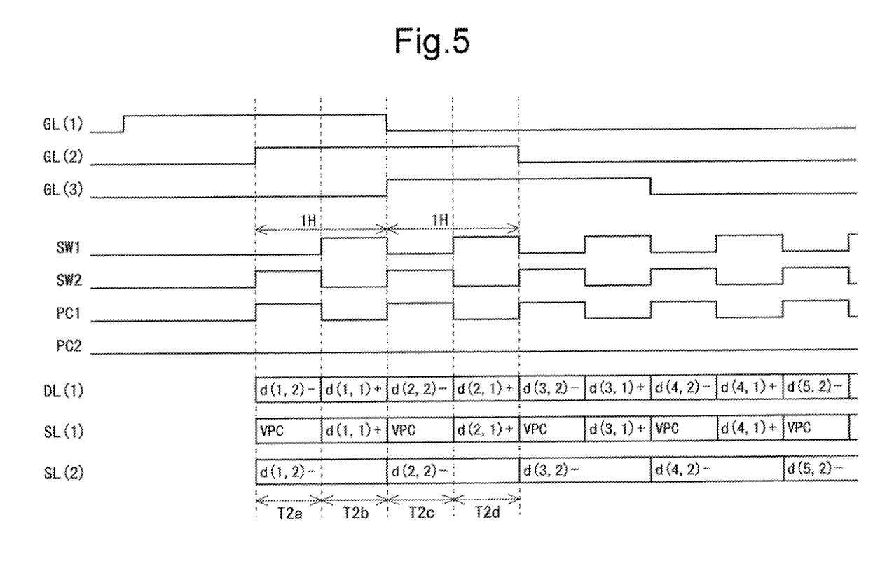

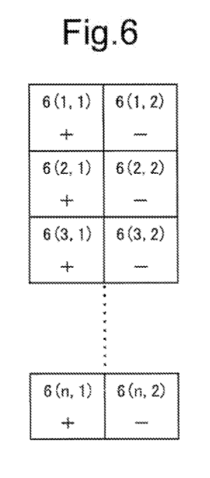

FIG. 5 is a timing chart for describing operation in the even-numbered frame. FIG. 6 is a diagram showing the polarities of the data writing in the respective pixel formation portions 6 in the even-numbered frame. As grasped from FIGS. 6 and 4, the polarity of the data writing in each of the pixel formation portions 6 is switched between the positive polarity and the negative polarity in each frame.

In the period T2a, the scanning signal G(1) and the scanning signal G(2) are at the high level. In such a state, to the data output line DL(1) is supplied data d(1,2)− for the pixel formation portion 6(1,2) as the video signal. At this time, the first switching control signal SW1 is at the low level, and the second switching control signal SW2 is at the high level. Accordingly, the TFT 40(1) is in an Off state, and the TFT 40(2) is in an On state. Thereby, the data d(1,2)− is supplied to the source bus line SL(2), and the data d(1,2)− is written in the pixel capacitance 66 in the pixel formation portion 6(1,2). At this time, the first precharge control signal PC1 is at the high level, and the second precharge control signal PC2 is at the low level. Accordingly, the TFT 50(1) is in an On state, and the TFT 50(2) is in an Off state. This allows the precharge voltage VPC to be applied to the source bus line SL(1).

Also in a period. T2b, the scanning signal G(1) and the scanning signal G(2) are at the high level. In such a state, to the data output line DL(1) is supplied data d(1,1)+ for the pixel formation. portion 6(1,1) as the video signal. At this time, in a state where the second precharge control signal PC2 is kept at the low level, the first precharge control signal PC1 is also at the low level. Thereby, since the TFT 50(1) is in an Off state, the application of the precharge voltage VPC to the source bus line SL(1) is stopped. Moreover, at this time, the first switching control signal SW1 is at the high level and the second switching control signal SW2 is at the low level. Accordingly, the TFT 40(1) is in an On state, and the TFT 40(2) is in an Off state. Thereby, the data d(1,1)+ is supplied to the source bus line SL(1), and the data d(1,1)+ is written in the pixel capacitance 66 in the pixel formation portion 6(1,1).

In a period T2c, in a state where the scanning signal G(2) and the scanning signal G(3) are at the high level, operation similar to that in the period T2a is performed. In a period T2d, in a state where the scanning signal G(2) and the scanning signal G(3) are at the high level, operation similar to that in the period T2b is performed. The above-described operation is repeated until the data writing in the pixel formation portions 6 in a final row ends.

As described above, when the one driving unit shown in FIG. 2 is focused on, in a former half of the odd-numbered frame, the video signal outputted from the source driver 300 is applied to the source bus line SL(1) and the precharge voltage VPC is applied to the source bus line SL(2), and in a latter half of the odd-numbered frame, the video signal outputted from the source driver 300 is applied to the source bus line SL(2). Moreover, in a former half of the even-numbered frame, the video signal outputted from the source driver 300 is applied to the source bus line SL(2) and the precharge voltage VPC is applied to the source bus line SL(1), and in a latter half of the even-numbered frame, the video signal outputted from the source driver 300 is applied to the source bus line SL(1).

That is, in each of the horizontal scanning periods, first, the data writing based on the video signal is performed to the pixel formation portions 6 to be subjected to the data writing of the negative polarity, and at the same time, the precharge of the source bus line SL connected to the pixel formation portions 6 to be subjected to the data writing of the positive polarity is performed. Thereafter, the data writing based on the video signal is performed to the pixel formation portions 6 to be subjected to the data writing of the positive polarity. Here, since the polarity of the data writing in each of the pixel formation portions 6 is switched between the positive polarity and the negative polarity every frame as described above, the source driver 300 differentiates output order of the data (in the present embodiment, the two pieces of data per each of the data output lines DL) outputted to each of the data output lines DL as the video signal in each horizontal scanning period, between in the odd-numbered frame and in the even-numbered frame (see the data of the video signal DL(1) in FIGS. 3 and 5).

In the above-described example, the operation performed in the period T1a, the period T1c, the period T2a, and the period T2c corresponds to a preliminary charging step, and the operation performed in the period T1b, the period T1d, the period T2b, and the period T2d corresponds to a primary charging step.

### 1.4 Simulation Result

Next, a simulation result in a conventional general configuration and a simulation result in the configuration according to the present embodiment will be described. With regard to both the data writing of positive polarity and the data writing of the negative polarity, a simulation when a data potential (potential of the video signal) changes from the lowest potential to the highest potential is performed. Specifically, for the data writing of the positive polarity, a simulation when the data potential changes from plus 5 V to plus 10 V is performed, and for the data writing of the negative polarity, a simulation when the data potential changes 0 V to plus 5 V is performed (a potential of the common electrode 64 is 5 V).

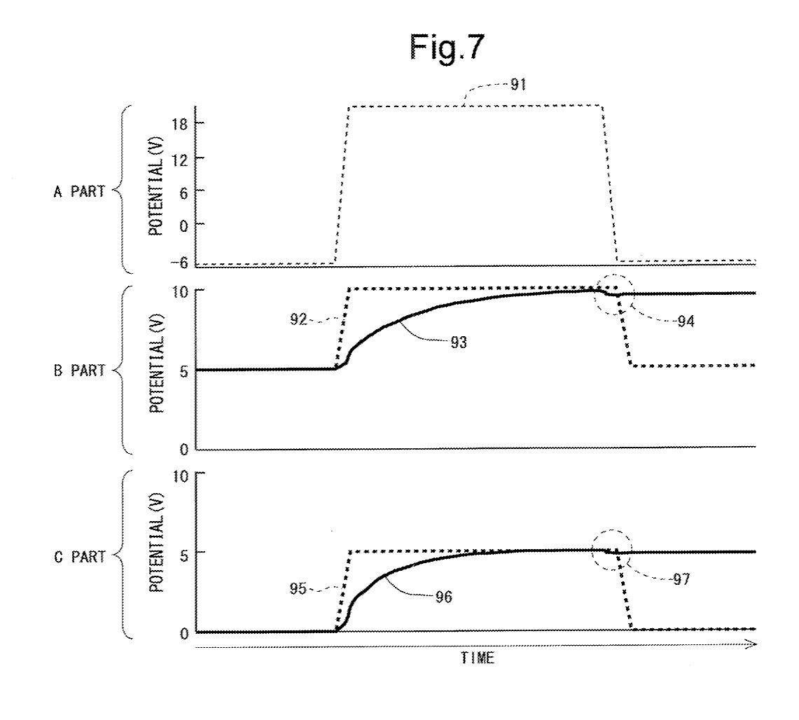

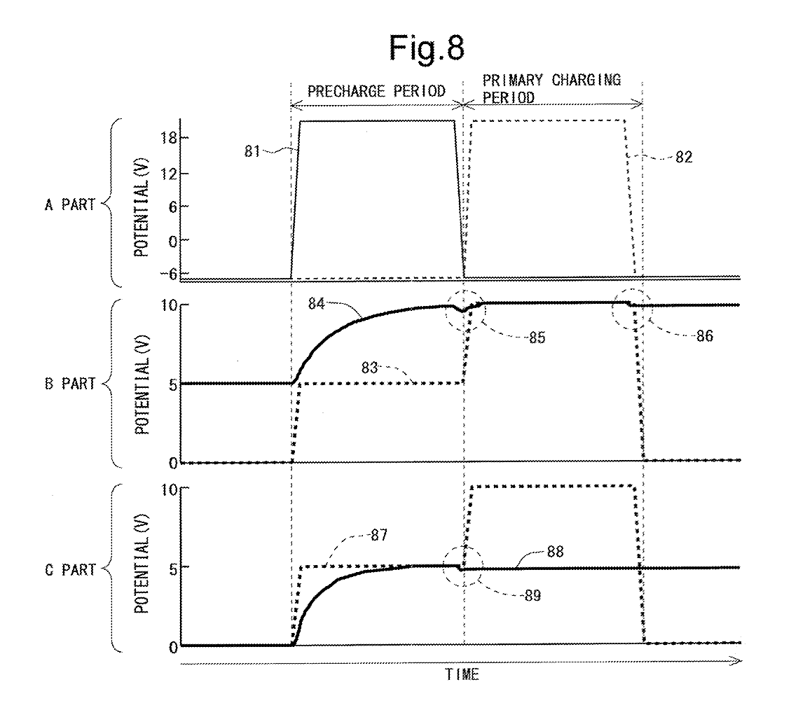

FIG. 7 is a diagram showing the simulation result in the conventional general configuration, and FIG. 8 is the simulation result in the configuration according to the present embodiment. In each of FIGS. 7 and 8, an A part slows a waveform of a signal that controls the charging of the source bus line, a B part shows how the source bus line is charged when the data writing of the positive polarity is performed, and a C part shows how the source bus line is charged when the data writing of the negative polarity is performed. With regard to FIG. 7, a dotted line with reference sign 91 indicates waveform of the control signal (when this control signal is at the high level, the video signal is applied to the source bus line), thick dotted lines with reference signs 92, 95 each indicate a waveform of the data potential, and thick solid lines with reference signs 93, 96 each indicate a waveform of a potential of the source bus line. Moreover, with regard to FIG. 8, a solid line with reference sign 81 indicates a waveform of the switching control signal that controls the application of the video signal to the source bus line connected to the pixel formation portions to be subjected to the data writing of the negative polarity (a waveform of the precharge control signal that controls the application of the precharge voltage to the source bus line connected to the pixel formation portions to be subjected to the data writing of the positive polarity also the same as this), a dotted line with reference sign 82 indicates a waveform of the switching control signal that controls the application of the video signal to the source bus line connected to the pixel formation portions to be subjected to the data writing of the positive polarity, thick dotted lines with reference signs 83, 87 each indicate a waveform of the data potential, and thick solid lines with reference signs 84, 88 each indicate a waveform of a potential of the source bus line. Note that in FIG. 8, a former half of the horizontal scanning period in the simulation is referred to as a “precharge period”, and a latter half thereof is referred to as a “primary charging period”.

When a portion with reference sign 97 in FIG. 7 is focused on, the source bus line is charged up to the data potential. However, when a portion with reference sign 94 in FIG. 7 is focused on, the source bus line is not sufficiently charged. In this manner, in the conventional general configuration, while insufficient charging is not caused at the time of the data writing of the negative polarity, the insufficient charging is caused at the time of the data writing of the positive polarity.

When a portion with reference sign 89 in FIG. 8 is focused on, the source bus line is charged up to the data potential. When a portion with reference sign 85 in FIG. 8 is focused on, the source bus lines is not sufficiently charged. However, when a portion with reference sign 86 in FIG. 8 is focused on, the source bus line is charged up to the data potential. In this manner, in the present embodiment, with regard to the data writing of the positive polarity, although the source bus line is not sufficiently charged only in the precharge period, the source bus line is sufficiently charged during the primary charging period after the precharge period. That is, with regard to the data writing of the positive polarity, by performing the precharge of the source bus line based on the maximum voltage of the video signal in advance, the source bus line is charged up to the data potential at the end time of the horizontal scanning period.

### 1.5 Effects

According to the present embodiment, the liquid crystal display device is provided with the precharge circuit 500 configured to apply the precharge voltage VPC to the source bus lines SL, and in each of the horizontal scanning periods, the precharge circuit 500 applies the precharge voltage VPC to only the source bus lines SL connected to the pixel formation portions 6 to be subjected to the data writing of the positive polarity before the video signal is applied to the relevant source bus lines SL. In this manner, since the precharge of the source bus lines SL connected to the pixel formation portions 6 to be subjected to the data writing of the positive polarity is performed, the occurrence of the insufficient charging when the charging at a high voltage is performed is suppressed. Moreover, since the precharge is not performed to the source bus lines SL connected to the pixel formation portions 6 to be subjected to the data writing of the negative polarity, a power consumption does not become unnecessarily large. From the foregoing, the liquid crystal display device capable of driving the source bus lines SL in a time division manner while suppressing an increase in the power consumption is realized

### 2. Second Embodiment

### 2.1 Outline and Overall Configuration

In the first embodiment, time-division driving of the source bus lines SL with the two source bus lines SL set as one group is performed. In contrast, in the present embodiment, time-division driving of the source bus lines SL with three source bus lines SL set as one group is performed. That is, the number of the data output lines DL is one third of the number of the source bus lines SL. Moreover, in the present embodiment, six source bus lines SL are one driving unit so that, when the one driving unit is focused on, the number of the source bus lines SL connected to the pixel formation portions 6 to be subjected to the data writing of the positive polarity and the number of the source bus lines SL connected to the pixel formation portions 6 to be subjected to the data writing of the negative polarity are equal in each horizontal scanning period. An overall configuration is similar to that of the first embodiment, and thus description thereof is omitted (see FIG. 1).

### 2.2 SSD Circuit and Precharge Circuit

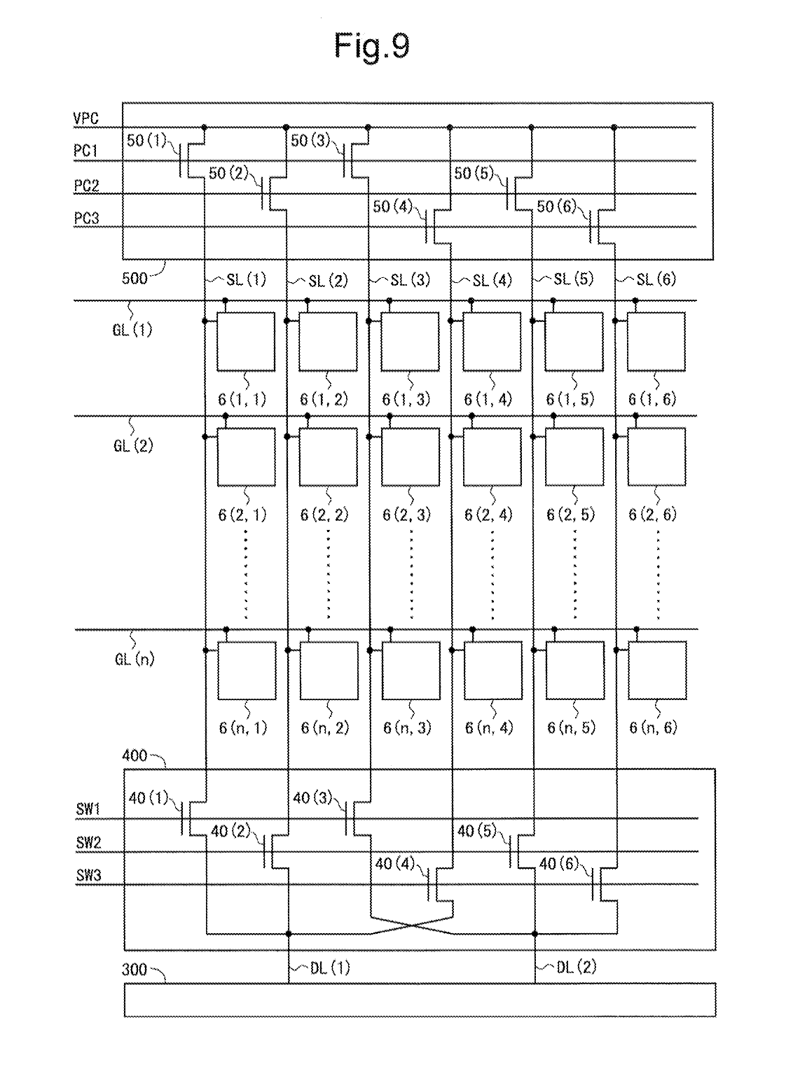

FIG. 9 is circuit diagram for describing a configuration of the SSD circuit 400 and the precharge circuit 500 in the present embodiment. In FIG. 9, only components corresponding to the one driving unit (specifically, components corresponding to source bus lines SL(1) to SL (6) in first to sixth columns) are shown.

To the SSD circuit 400 are inputted the first switching control signal SW1, the second switching control signal SW2, and a third switching control signal SW3 as the switching control signal SWCTL. To the precharge circuit 500 are inputted the first precharge control signal PC1, the second precharge control signal PC2, and a third precharge control signal PC3 as the precharge control signal PCTL. Moreover, to the precharge circuit 500 is supplied the precharge voltage VPC from the predetermined power supply circuit. The precharge voltage VPC is set to the maximum voltage of the video signal when the data writing of the positive polarity is performed as in the first embodiment.

As shown in FIG. 9, the SSD circuit 400 is provided with the TFT 40(1) configured to control an electrical connection state between the data output line DL(1) and the source bus line SL(1), the TFT 40(2) configured to control an electrical connection state between the data output line DL(1) and the source bus line SL(2) a TFT 40(3) configured to control an electrical connection state between a data output line DL(2) and a source bus line SL(3), a TFT 40(4) configured to control an electrical connection state between the data output line DL(1) and a source bus line SL(4), a TFT 40(5) configured to control an electrical connection state between the data output line DL(2) and a source bus line SL(5), and a TFT 40(6) configured to control an electrical connection state between the data output line DL(2) and a source bus line SL(6). The TFTs 40(1) to 40(6) are n-channel thin film transistors. As shown in FIG. 9, the first switching control signal SW1 is supplied to gate terminals of the TFT 40(1) and the TFT 40(3), the second switching control signal SW2 is suppled to gate terminals of the TFT 40(2) and the TFT 40(5), and the third switching control signal SW3 is supplied to gate terminals of the TFT 40(4) and the TFT 40(6).

In the above-described configuration, when the video signal is to be applied to the source bus line SL(1) and the source bus line SL(3), the display control circuit 100 sets the first switching control signal SW1 to the high level, and sets the second switching control signal SW2 and the third switching control signal SW3 to the low level. This brings the TFT 40(1) and the TFT 40(3) into an On state, and the TFT 40(2), the TFT 40(4), the TFT 40(5), and the TFT 40(6) into an Off state, so that the dates output line DL(1) is electrically connected to the source bus line SL(1), and the data output line DL(2) is electrically connected to the source bus line SL(3). Similarly, when the video signal is to be applied to the source bus line SL(2) and the source bus line SL(5), the display control circuit 100 sets only the second switching control signal SW2 of the switching control signal SWCTL to the high level, and when the video signal is to be applied to the source bus line SL(4) and the source bus line SL(6), the display control circuit 100 sets only the third switching control signal SW3 of the switching control signal SWCTL to the high level. Note that, of the components shown in FIG. 9, the TFTs 40(1) to 40(6) each correspond to a connection control transistor.

As shown in FIG. 9, the precharge circuit 500 is provided with TFTs 50(1) to 50(6) configured to control electrical connection states between the precharge power line and the source bus lines SL(1) to SL(6), respectively. The TFTs 50(1) to 50(6) are n-channel thin film transistors. As shown in FIG. 9, the first precharge control signal PC1 is supplied to gate terminals of the TFT 50(1) and the TFT 50(3), the second precharge control signal PC2 is supplied to gate terminals of the TFT 50(2) and the TFT 50(5), and the third precharge control signal PC3 is supplied to gate terminals of the TFT 50(4) and the TFT 50(6).

In the above-described configuration, when the precharge voltage VPC is to be applied to the source bus line SL(1) and the source bus line SL(3), the display control circuit 100 sets the first precharge control signal PC1 to the high level. This brings the TFT 50(1) and the TFT 50(3) into an On state, so that the precharge power line is electrically connected to the source bus line SL(1) and the source bus line SL(3). Similarly, when the precharge voltage VPC is to be applied to the source bus line SL(2) and the source bus line SL(5), the display control circuit 100 sets the second precharge control signal PC2 to the high level, and when the precharge voltage VPC is to be applied to the source bus line SL(4) and the source bus line SL(6), the display control circuit 100 sets the third precharge control signal PC3 to the high level.

### 2.3 Driving Method

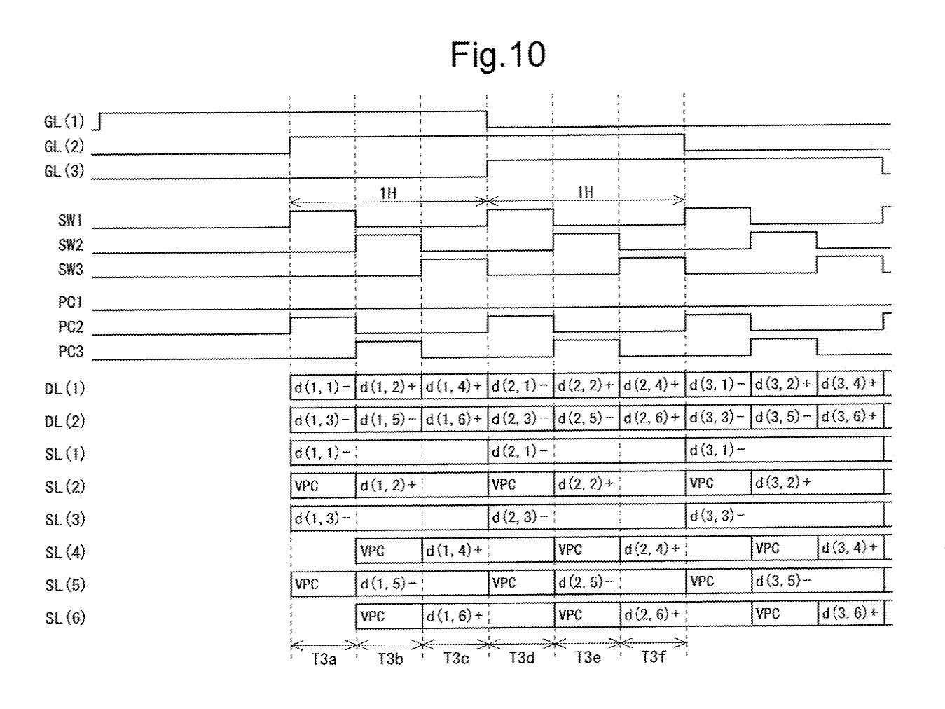

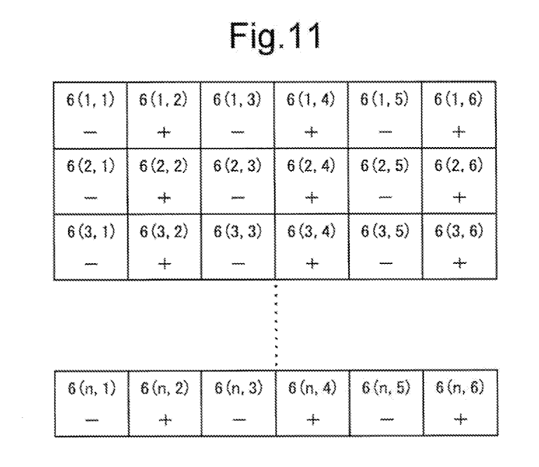

Next, a driving method will be described. In the present embodiment, as in the first embodiment, the so-called “column-reversal driving” is also employed, and the polarity of the data writing is reversed in each of the pixel formation portions 6 every frame. FIG. 10 is a timing chart for describing operation in the odd-numbered frame. FIG. 11 is a diagram showing the polarities of the data writing in the respective pixel formation portions 6 in the odd-numbered frame.

In a period T1a, the scanning signal G(1) and the scanning signal G(2) are at the high level. In such a state, to the data output line DL(1) is supplied the data d(1,1)− for the pixel formation portion 6(1,1) as the video signal, and to the data output line DL(2) is supplied data d(1,3)− for a pixel formation portion 6(1,3) as the video signal. At this time, with regard to the switching control signal SWCTL, only the first switching control signal SW1 is at the high level. Accordingly, the TFT 40(1) and the TFT 40(3) are in an On state. Thereby, the data d(1,1)− is supplied to the source bus line SL(1) and the data d(1,1)− is written in the pixel capacitance 66 in the pixel formation portion 6(1,1), and data d(1,3)− is supplied to the source bus line SL(3) and the data d(1,3)− is written in the pixel capacitance 66 in the pixel formation portion 6(1,3). Moreover, at this time, with regard to the precharge control signal PCTL, only the second precharge control signal PC2 is at the high level. Accordingly, the TFT 50(2) and the TFT 50(5) are in an On state. This allows the precharge voltage VPC to be applied to the source bus line SL(2) and the source bus line SL(5).

Also in a period T3b, the scanning signal G(1) and the scanning signal G(2) are at the high level. In such a state, to the data output line DL(1) is supplied the data d(1,2)+ for the pixel formation portion 6(1,2) as the video signal, and to the data output line DL(2) is supplied data d(1,5)− for a pixel formation portion 6(1,5) as the video signal. At this time, with regard to the switching control signal SWCTL, only the second switching control signal SW2 is at the high level. Accordingly, the TFT 40(2) and the TFT 40(5) are in an On state. Thereby, the data d(1,2)+ is supplied to the source bus line SL(2) and the data d(1,2)+ is written in the pixel capacitance 66 in the pixel formation portion 6(1,2), and the data d(1,5)− is suppled to the source bus line SL(5) and the data d(1,5)− is written in the pixel capacitance 66 in the pixel formation portion 6(1,5). Moreover, at this time, with regard to the precharge control signal PCTL, only the third precharge control signal PC3 is at the high level. Accordingly, the TFT 50(4) and the TFT 50(6) are in an On state. This allows the precharge voltage VPC to be applied to the source bus line SL(4) and the source bus line SL(6). Note that, since the second precharge control signal PC2 is at the low level, the TFT 50(2) and the TFT 50(5) are in an Off state, so that the application of the precharge voltage VPC to the source bus line SL(2) and the source bus line SL(5) is stopped.

Also in a period T3c, the scanning signal G(1) and the scanning signal G(2) are at the high level. In such a state, to the data output line DL(1) is supplied data d(1,4)+ for a pixel formation portion 6(1,4) as the video signal, and to the data output line DL(2) is supplied data d(1,6)+ for a pixel formation portion 6(1,6) as the video signal. At this time, with regard to the switching control signal SWCTL, only the third switching control signal SW3 is at the high level. Accordingly, the TFT 40(4) and the TFT 40(6) are in an On state. Thereby, the data d(1,4)+ is supplied to the source bus line SL(4) and the data d(1,4)+ is written in the pixel capacitance 66 in the pixel formation. portion 6(1,4), and the data d(1,6)+ is supplied to the source bus line SL(G) and the data d(1,6)+ is written in the pixel capacitance 66 in the pixel formation portion 6(1,6). Note that, since the third precharge control signal PC3 is at the low level, the TFT 50(4) and the TFT 50(6) are in an Off state, so that the application of the precharge voltage VPC to the source bus line SL(4) and the source bus line SL(6) is stopped.

In a period T3d, in the state where the scanning signal G(2) and the scanning signal G(3) are at the high level, operation similar to that in the period T3a is performed. In a period T3e, in the state where the scanning signal G(2) and the scanning signal G(3) are at the high level, operation similar to that in the period T3b is performed. In a period T3f, in the state where the scanning signal G(2) and the scanning signal G(3) are at the high level, operation similar to that in the period T3c is performed. The above-described operation is repeated until the data writing in the pixel formation portions 6 in a final row ends.

Note that although the source bus line SL(5) is connected to the pixel formation portions 6 to be subjected to the data writing of the negative polarity, the precharge voltage VPC is applied to the source bus line SL(5), for example, in the period T1a or the period T3d. Although the maximum voltage of the video signal when the data writing of the positive polarity is performed is applied to the source bus line SL(5) before the original video signal is applied in this manner, there arises no special problem on the operation.

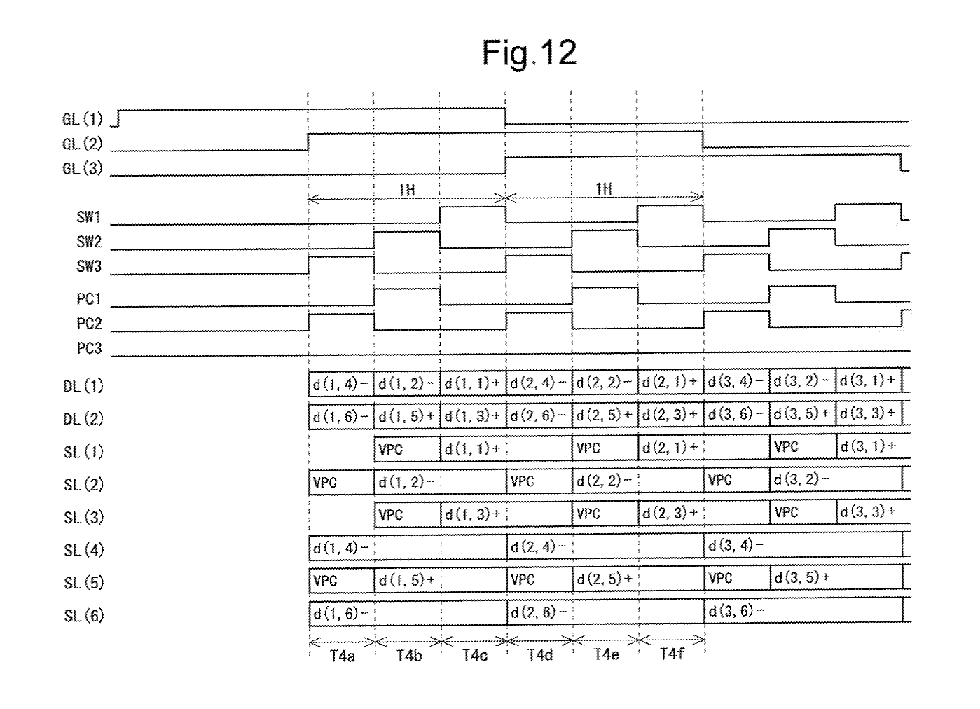

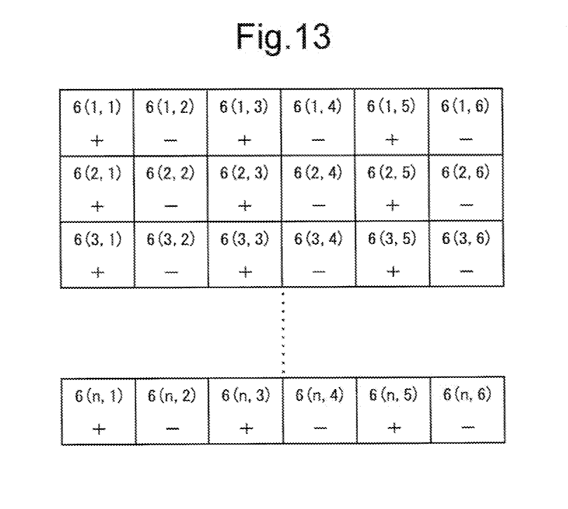

FIG. 12 is a timing chart for describing operation in the even-numbered frame. FIG. 13 is a diagram showing the polarities of the data writing in the respective pixel formation portions 6 in the even-numbered frame.

In a period T4a, the scanning signal G(1) and the scanning signal G(2) are at the high level. In such a state, to the data output line DL(1) is supplied data d(1,4)− for the pixel formation portion 6(1,4) as the video signal, and to the data output line DL(2) is supplied data d(1,6)− for the pixel formation portion 6(1,6) as the video signal. At this time, with regard to the switching control signal SWCTL, only the third switching control signal SW3 is at the high level. Accordingly, the TFT 40(4) and the TFT 40(6) are in an On state. Thereby, the data d(1,4)− is supplied to the source bus line SL(4), and the data d(1,4)− is written in the pixel capacitance 66 in the pixel formation portion 6(1,4), and the data d(1,6)− is supplied to the source bus line SL(6), and the data d(1,6)− is written in the pixel capacitance 66 in the pixel formation portion 6(1,6). Moreover, at this time, with regard to the precharge control signal PCTL, only the second precharge control signal PC2 is at the high level. Accordingly, the TFT 50(2) and the TFT 50(5) are in an On state. This allows the precharge voltage VPC to be applied to the source bus line SL(2) and the source bus line SL(5).

Also in a period T4b, the scanning signal G(1) and the scanning signal G(2) are at the high level. In such a state, to the data output line DL(1) is supplied the data d(1,2)− for the pixel formation portion 6(1,2) as the video signal, and to the data output line DL(2) is supplied data d(1,5)+ for the pixel formation portion 6(1,5) as the video signal. At this time, with regard to the switching control signal SWCTL, only the second switching control signal SW2 is at the high level. Accordingly, the TFT 40(2) and the TFT 40(5) are in an On state. Thereby, the data d(1,2)− is supplied to the source bus line SL(2) and the data d(1,2)− is written in the pixel capacitance 66 in the pixel formation portion 6(1,2), and the data d(1,5)+ is supplied to the source bus line SL(5) and the data d(1,5)+ is written in the pixel capacitance 66 in the pixel formation portion 6(1,5). Moreover, at this time, with regard to the precharge control signal PCTL, only the first precharge control signal PC1 is at the high level. Accordingly, the TFT 50(1) and the TFT 50(3) are in an On state. This allows the precharge voltage VPC to be applied to the source bus line SL(1) and the source bus line SL(3). Note that, since the second precharge control signal PC2 is at the low level, the TFT 50(2) and the TFT 50(5) are in an Off state, so that the application of the precharge voltage VPC to the source bus line SL(2) and the source bus line SL(5) is stopped.

Also in a period T4c, the scanning signal G(1) and the scanning signal G(2) are at the high level. In such a state, to the data output line DL(1) is supplied the data d(1,1)+ for the pixel formation portion 6(1,1) as the video signal, and to the data output line DL(2) is supplied data d(1,3)+ for the pixel formation portion 6(1,3) as the video signal. At this time, with regard to the switching control signal SWCTL, only the first switching control signal SW1 is at the high level. Accordingly, the TFT 40(1) and the TFT 40(3) are in an On state. Thereby, the data d(1,1)+ is supplied to the source bus line SL(1) and the data d(1,1)+ is written in the pixel capacitance 66 in the pixel formation portion 6(1,1), and the data d(1,3)+ is supplied to the source bus line SL(3) and the data d(1,3)+ is written in the pixel capacitance 66 in the pixel formation portion 6(1,3). Note that, since the first precharge control signal PC1 is at the low level, the TFT 50(1) and the TFT 50(3) are in an Off state, so that the application of the precharge voltage VPC to the source bus line SL(1) and the source bus line SL(3) is stopped.

In a period T4d, in the state where the scanning signal G(2) and the scanning signal G(3) are at the high level, operation similar to that in the period T4a is performed. In a period T4e, in the state where the scanning signal G(2) and the scanning signal G(3) are at the high level, operation similar to that in the period T4b is performed. In a period T4f, in the state where the scanning signal G(2) and the scanning signal G(3) are at the high level, operation similar to that in the period T4c is performed. The above-described operation is repeated until the data writing in the pixel formation portions 6 in a final row ends.

As described above, in each of the horizontal scanning periods, to the source bus lines SL connected to the pixel formation portions 6 to be subjected to the data writing of the positive polarity, the video signal is applied after the precharge voltage VPC is applied beforehand.

In the above-described example, the operation performed in the period T3a, the period T3b, the period T3d, the period T3e, the period T4a, the period T4b, the period T4d, and the period T4e corresponds to the preliminary charging step, and the operation performed in the period T3c, the period T3f, the period T4c, and the period T4f corresponds to the primary charging step.

### 2.4 Effects

According to the present embodiment, as in the first embodiment, since the precharge of the source bus lines SL connected to the pixel formation portions 6 to be subjected to the data writing of the positive polarity is performed, the occurrence of the insufficient charging when the charging at a high voltage is performed is suppressed. Moreover, since the precharge is not performed to the source bus lines SL connected to the pixel formation portions 6 to be subjected to the data writing of the negative polarity except for a part thereof (e.g., the source bus line SL(5) in FIG. 10, and the source bus line SL(2) in FIG. 12), a power consumption does not become unnecessarily large. From the foregoing, the liquid crystal display device capable of driving the source bus lines SL in a time division manner while suppressing an increase in the power consumption is realized

### 3. Modification

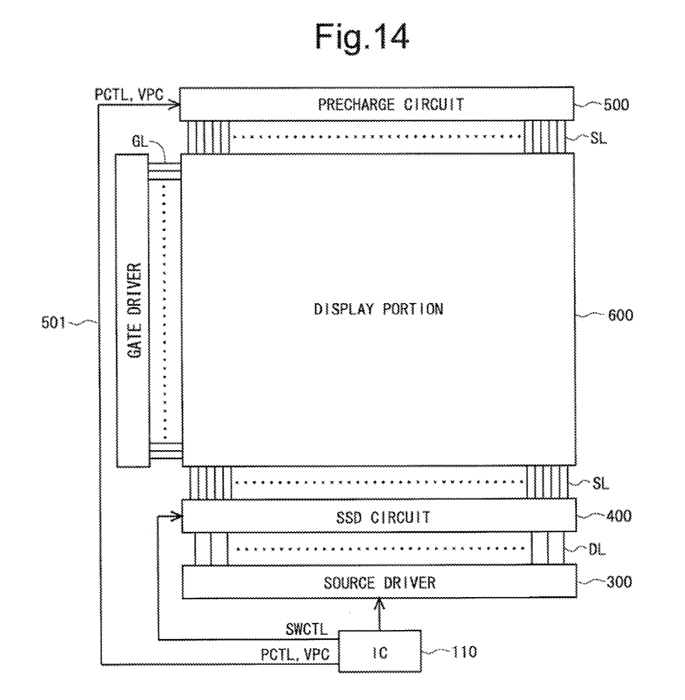

In each of the above-described embodiments, the precharge circuit 500 is arranged so that the application of the precharge voltage VPC to the source bus lines SL is performed from an opposite side of the application of the video signal. That is, as shown in FIG. 1, the source driver 300 and the SSD circuit 400 are arranged on one end side of the source bus lines SL, and the precharge circuit 500 is arranged on another end side of the source bus lines SL. However, if an IC (e.g., the display control circuit 100 in FIG. 1) 110 configured to generate the various control signals and the like is arranged on the same side as the source driver 300 with respect to the display portion 600 as shown in FIG. 14 in the case where the above-described configuration is employed, there arises a need for arranging wiring configured to transmit the various control signals and the like to the precharge circuit 500 to bypass the display portion 600 as indicated by reference sign 501 in FIG. 14. This causes enlargement of a picture-frame region beside the display portion 600.

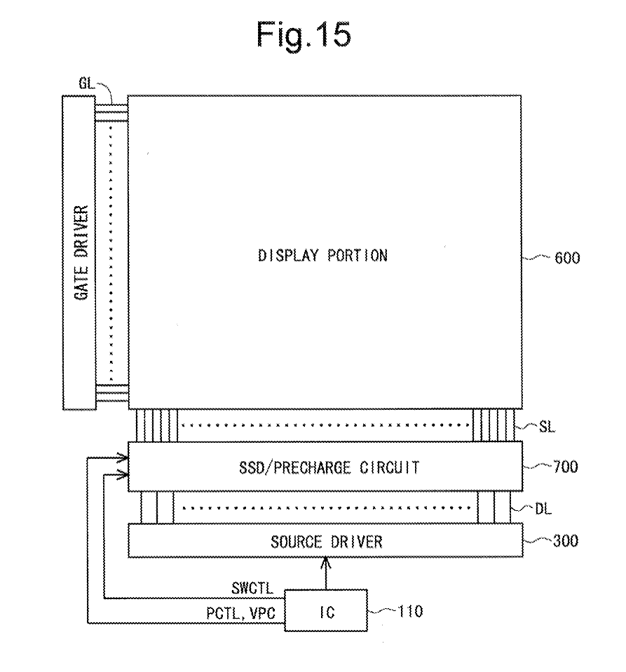

Thus, as a modification of each of the above-described embodiments, a configuration will be described in which the precharge circuit is arranged on the same side as the source driver with respect to the display portion (with respect to the plurality of pixel formation portions). In the present modification, an SSD/precharge circuit 700 having the function of the above-described SSD circuit and the function of the above-described precharge circuit is provided in a region between the display portion 600 and the source driver 300, as shown in FIG. 15.

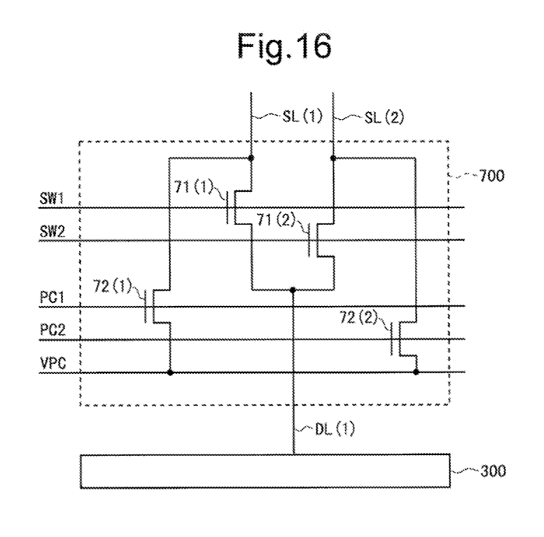

FIG. 16 is a circuit diagram showing a configuration of the SSD/precharge circuit 700 in the case where the configuration according to the present modification is applied to the first embodiment. Here, only components corresponding to the one driving unit (components corresponding to the source bus lines SL(1), SL(2) in the first column and the second column) are focused on. In the case where the configuration according to the present modification is applied to the first embodiment, as shown in FIG. 16, in the SSD/precharge circuit 700, there are provided two TFTs (TFT 71(1) and TFT 71(2)) configured to control the application of the video signal to the corresponding source bus line SL, and two TFTs (TFT 72(1) and TFT 72(2)) configured to control the application of the precharge voltage VPC to the corresponding source bus line SL.

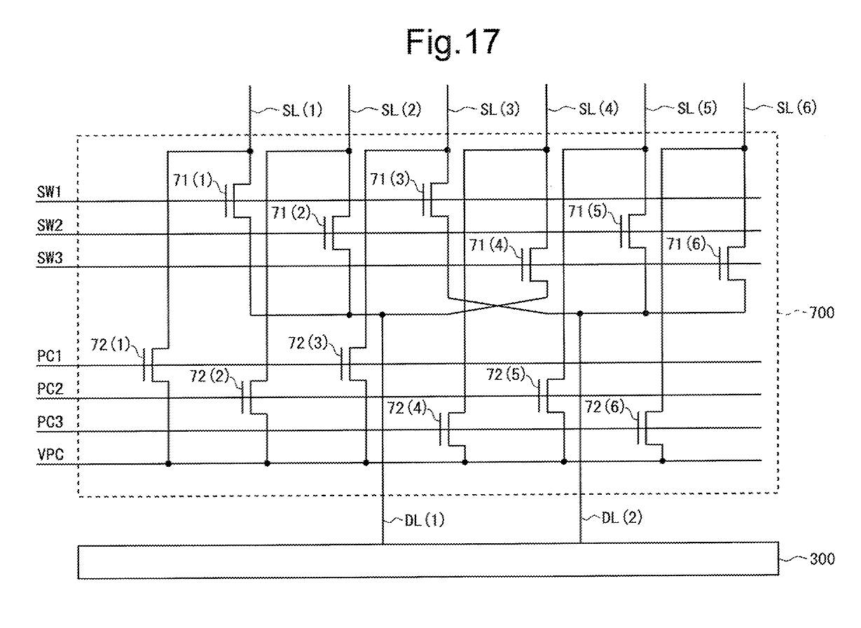

FIG. 17 is a circuit diagram showing the configuration of the SSD/precharge circuit 700 in the case where the configuration of the present modification is applied to the second embodiment. Here, only components corresponding to the one driving unit (components corresponding to the source bus lines SL(1) to SL(6) in the first to sixth columns) are focused on. In the case where the configuration according to the present modification is applied to the second embodiment, as shown in FIG. 17, in the SSD/precharge circuit 700, there are provided six TFTs (TFTs 71(1) to 71(6)) configured to control the application of the video signal to the corresponding source bus line SL, and six TFTs (TFTs 72(1) to 72(6)) configured to control the application of the precharge voltage VPC to the corresponding source bus line SL.

Here, in FIGS. 16 and 17, for example, components corresponding to the source bus line SL(1) are focused on. With regard to the TFT 71(1), the first switching control signal SW1 is supplied to a gate terminal, a drain terminal is connected to the data output line DL(1), and a source terminal is connected to the source bus line SL(1). With regard to the TFT 72(1), the first precharge control signal PC1 is supplied to a gate terminal, a drain terminal is connected to the precharge power line, and a source terminal is connected to the source bus line SL(1). The source terminal of the TFT 71(1) and the source terminal of the TFT 72(1) are electrically connected to each other in the SSD/precharge circuit 700

According to the above-described present modification, a liquid crystal display device capable of driving the video signal lines in a time division manner while suppressing an increase in power consumption, without causing enlargement of the picture-frame region beside the display portion 600. However, according to the present modification, there arises a need for enlarging the picture-frame region on a side of the source driver 300 with respect to the display portion 600. Accordingly it is preferable that an arrangement position of the precharge circuit is decided in accordance with a specification of a design of the liquid crystal display device.

### 4. Others

In the first embodiment, two source bus lines SL are set as one group to perform the time-division driving of the source bus lines SL, and in the second embodiment, three source bus lines SL are set as one group to perform the time-division driving of the source bus lines SL. However, the present invention is not limited to the foregoing, and the present invention can also be applied to a case where four or more source bus lines SL are set as one group to perform the time-division driving of the source bus lines SL.

Moreover, although the cases where the n-channel TFTs are employed have been exemplified and described in each of the above-described embodiments (including the modification), the present invention can be applied to a case where p-channel TFTs are employed. In this case, in each of the horizontal scanning periods, the precharge circuit 500 applies the precharge voltage VPC to the source bus lines SL connected to the pixel formation portions 6 to be subjected to the data writing of the negative polarity before the video signal outputted from the source driver 300 is applied to the source bus lines SL. Note that the precharge voltage VPC is set to a minimum voltage of the video signal when the data writing of the negative polarity is performed. Moreover, in each of the horizontal scanning periods, the SSD circuit 400 switches the source bus lines SL of the connection destinations of the data output lines DL so that the video signal outputted from the source driver 300 is applied to the source bus lines SL connected to the pixel formation portions 6 to be subjected to the data writing of the positive polarity relatively prior to the source bus lines SL connected to the pixel formation portions 6 to be subjected to the data writing of the negative polarity.

While the present invention has been described in detail above, the above description is to be considered in all respects as illustrative and not restrictive. It will be understood that many other changes and modifications can be made without departing from the scope of the present invention.

What is claimed is:

1. A display device comprising a plurality of video signal lines, a plurality of scanning signal lines intersecting with the plurality of video signal lines, a plurality of pixel formation portions arranged corresponding to respective intersections between the plurality of video signal lines and the plurality of scanning signal lines, and a scanning signal line drive circuit configured to drive the plurality of scanning signal lines, the display device comprising:
a video signal line drive circuit configured to output a video signal to a data output line in a time division manner in each horizontal scanning period, the data output line corresponding to each video signal line group obtained by grouping the plurality of video signal lines with K video signal lines set as one group, where K is an integer of two or more;
a connection switching circuit including a connection control transistor configured to control an electrical connection state between each of the video signal lines and the data output line corresponding thereto, the connection switching circuit configured to switch a connection destination of the data output line corresponding to each of the video signal line groups among the K video signal lines configuring each of the video signal line groups in a time division manner in each of the horizontal scanning periods; and
a preliminary charging circuit configured to apply a preliminary charging voltage to the plurality of video signal lines,
wherein in a case where the connection control transistor is of an n-channel type,
in each of the horizontal scanning periods, the preliminary charging circuit applies the preliminary charging voltage to the video signal line connected to the pixel formation portions to be subjected to data writing of a positive polarity before the video signal outputted from the video signal line drive circuit is applied to the video signal line, and
in each of the horizontal scanning periods, the connection switching circuit switches the video signal line of the connection destination of the data output line so that the video signal outputted from the video signal line drive circuit is applied to the video signal line connected to the pixel formation portions to be subjected to the data writing of a negative polarity relatively prior to the video signal line connected to the pixel formation portions to be subjected to the data writing of the positive polarity,
in a case where the connection control transistor is of a p-channel type,
in each of the horizontal scanning periods, the preliminary charging circuit applies the preliminary charging voltage to the video signal line connected to the pixel formation portions to subjected to the data writing of the negative polarity before the video signal outputted from the video signal line drive circuit is applied to the video signal line, and
in each of the horizontal scanning period, the connection switching circuit switches the video signal line of the connection destination of the data output line so that the video signal outputted from the video signal line drive circuit is applied to the video signal line connected to the pixel formation portions to be subjected to the data writing of the positive polarity relatively prior to the video signal line connected to the pixel formation portions to be subjected to the data writing of the negative polarity.

2. The display device according to claim 1, wherein
a polarity of the data writing in each of the pixel formation portions is switched between a positive polarity and a negative polarity every frame, and
the video signal line drive circuit differentiates output order of K pieces of data between in an odd-numbered frame and in an even-numbered frame, the K pieces of data being outputted as the video signal to the data output line in each of the horizontal scanning periods.

3. The display device according to clam 2, wherein
the K is two, and
when two video signal lines configuring each of the video signal line groups are defined as a first video signal line and a second video signal line,
in a former half of the odd-numbered frame, the video signal outputted from the video signal line drive circuit is applied to the first video signal line, and the preliminary charging voltage is applied to the second video signal line,
in a latter half of the odd-numbered frame, the video signal outputted from the video signal line drive circuit is applied to the second video signal line,
in a former half of the even-numbered frame, the video signal outputted from the video signal line drive circuit is applied to the second video signal line, and the preliminary charging voltage is applied to the first video signal line, and
in a latter half of the even-numbered. frame, the video signal outputted from the video signal line drive circuit is applied to the first video signal line.

4. The display device according to claim 2, wherein
the K is three,
when six video signal lines are one driving unit, and
the six video signal lines configuring each of the driving units are defined as a first video signal line, a second video signal line, third video signal line, a fourth video signal line, a fifth video signal line, and a sixth video signal line, and three periods obtained by dividing each of the horizontal scanning periods into three are defined as a first period, second period, and a third period,
in the first period of the odd-numbered frame, the video signal outputted from the video signal line drive circuit is applied to the first video signal line and the third video signal line, and the preliminary charging voltage is applied to at least the second video signal line,
in the second period of the odd-numbered frame, the video signal outputted from the video signal line drive circuit is applied to the second video signal line and the fifth video signal line, and the preliminary charging voltage is applied to the fourth video signal line and the sixth video signal line,
in the third period of the odd-numbered frame, the video signal outputted from the video signal line drive circuit is applied to the fourth video signal line and the sixth video signal line,
in the first period of the even-numbered frame, the video signal outputted from the video signal line drive circuit is applied to the fourth video signal line and the sixth video signal line, and the preliminary charging voltage is applied to at least the fifth video signal line,
in the second period of the even-numbered frame, the video signal outputted from the video signal line drive circuit is applied to the second video signal line and the fifth video signal line, and the preliminary charging voltage is applied to the first video signal line and the third video signal line, and
in the third period of the even-numbered frame, the video signal outputted from the video signal line drive circuit is applied to the first video signal line and the third video signal line.

5. The display device according to claim 1, wherein
in the case where the connection control transistor is of the n-channel type, the preliminary charging voltage is set to a maximum voltage of the video signal when the data writing of the positive polarity is performed, and
in the case where the connection control transistor is of the p-channel type, the preliminary charging voltage is set to a minimum voltage of the video signal when the data writing of the negative polarity is performed.

6. The display device according to claim 1, wherein
the connection switching circuit is arranged in a region between the plurality of pixel formation portions and the video signal line drive circuit, and
the preliminary charging circuit is arranged on an opposite side of the connection switching circuit with respect to the plurality of pixel formation portions.

7. The display device according to claim 1, wherein the video signal line drive circuit, the connection switching circuit, and the preliminary charging circuit are arranged on a same side with respect to the plurality of pixel formation portions.

8. A method for driving a display device including a plurality of video signal lines, a plurality of scanning signal lines intersecting with the plurality of video signal lines, a plurality of pixel formation portions arranged corresponding to respective intersections between the plurality of video signal lines and the plurality of scanning signal lines, a scanning signal line drive circuit configured to drive the plurality of scanning signal lines, a video signal line drive circuit configured to output a video signal to a data output line in a time division. manner in each horizontal scanning period, and a connection switching circuit including a connection control transistor configured to control an electrical connection state between each of the video signal lines and the data output line corresponding thereto, the data output line corresponding to each video signal line group obtained by grouping the plurality of video signal lines with K video signal lines set as one group, where K is an integer of two or more, the connection switching circuit configured to switch a connection destination of the data output line corresponding to each of the video signal line groups among the K video signal lines configuring each of the video signal line groups, the method comprising:
a preliminary charging step of switching the connection destination of the data output line by the connection switching circuit so that, in case where the connection control transistor is of an n-channel a preliminary charging voltage is applied to the video signal line connected to the pixel formation portions to be subjected to data writing of a positive polarity and the video signal outputted from the video signal line drive circuit is applied to the video signal line connected to the pixel formation portions to be subjected to the data writing of a negative polarity, and in a case where the connection control transistor is of a p-channel type, the preliminary charging voltage is applied to the video signal line connected to the pixel formation portions to be subjected to the data writing of the negative polarity and the video signal outputted from the video signal line drive circuit is applied to the video signal line connected to the pixel formation portions to be subjected to the data writing of the positive polarity; and
a primary charging step of switching the connection destination of the data output line by the connection switching circuit so that, in the case where the connection control transistor is the n-channel type, the video signal outputted from the video signal line drive circuit is applied to the video signal line connected to the pixel formation portions to be subjected to the data writing of the positive polarity, and in the case where the connection control transistor is of the p-channel type, the video signal outputted from the video signal line drive circuit is applied to the video signal line connected to the pixel formation portions to be subjected to the data writing of the negative polarity.
